(19) United States
(12) Patent Application Publication
(10) Pub. No.: US 2015/0197219 A1
(43) Pub. Date: Jul. 16, 2015

(54) Vehicle Inflation Device

(71) Applicants: Ying-Tsai Shih, Lukang Township (TW); Ching-Chieh Lin, Hemei Township (TW)

(72) Inventors: Ying-Tsai Shih, Lukang Township (TW); Ching-Chieh Lin, Hemei Township (TW)

(21) Appl. No.: 14/151,924

(22) Filed: Jan. 10, 2014

(51) Int. Cl. B60S 5/04

(52) U.S. Cl. CPC B60S 5/043

(57) ABSTRACT

A vehicle inflation device includes a hollow body having a front opening formed in a front end thereof and adapted for connecting with a vehicle exhaust pipe. Two corresponding through-holes are disposed in the hollow body for installation of an atmospheric relief valve. A guiding pipe is disposed on a rear end of the hollow body, and a check valve is disposed in the guiding pipe. The guiding pipe is engaged with an end of a flexible rubber pipe, and a gas nipple connector is disposed on another end of the flexible rubber pipe for engaging with a tire gas nipple. The vehicle inflation device further includes a retractable pipe assembly. An end of the retractable pipe assembly is hooked to a steering wheel, and another end of the retractable pipe assembly is pressed against an accelerator pedal for maintaining gas exhaustion to achieve inflation of a tire.

### BACKGROUND OF THE INVENTION

The present invention relates to a vehicle inflation device and, more particularly, to a vehicle inflation device for connecting to a vehicle exhaust pipe for inflating tires.

Taiwan Utility Model No. M401699 discloses an air inflation joint including a pipe body, a stretch member, a flexible rubber sleeve, an actuate member and a grip member. A gas passage is formed in the pipe body and includes an inflating end and an exhausting end. The pipe body includes a connection section adjacent to the inflating end and a gripping section adjacent to the exhausting end. The stretch member is connected to the connection section. The flexible rubber sleeve is sleeved with outer sides of the inflating end of the pipe body and the stretch member. The actuate member is extended into the connection section and pressed against the stretch member. After the flexible rubber sleeve is connected to a vehicle exhaust pipe and the inflating end is connected to a gas pipe, a user can operate the actuate member to push and press against the stretch member, so that the stretch member can stretch the flexible rubber sleeve outwardly for forming an airtight effect. Thereby, the gas exhausted from the exhaust pipe can be used for inflating to-be-inflated equipment or devices through the exhausting end, and therefore inflation can be achieved speedily.

With the stretch member of the conventional air inflation joint radially and outwardly expanded, the flexible rubber sleeve sleeved on the outer side of the stretch member can be stretched open for placing tightly against an inner wall of the exhaust pipe. However, the stretch member is composed of many components which will increase the manufacturing costs and make the manufacturing procedures complicated. More specifically, the stretch member includes a first pivotal connection ring, a second pivotal connection ring, a plurality of first pivotal connection strips, a plurality of second pivotal connection strips, a plurality of pivotal connection pieces, a plurality of stretching pieces, and a plurality of rivets. The first and second pivotal connection rings are respectively disposed with a plurality of first and second pivotal connection grooves annularly. The first and second pivotal connection rings are also respectively disposed with first and second connection strips for connecting with the first and second pivotal connection strips. The first and second pivotal connection strips are pivotally connected with the first and second pivotal connection grooves sequentially, and the first and second pivotal connection strips are pivotally connected with two end portions of the pivotal connection pieces respectively. The stretching pieces are pivotally connected with pivotal connections between the first pivotal connection strips and the pivotal connection pieces and pivotal connections between the second pivotal connection strips and the pivotal connection pieces respectively by the rivets. An internal passage of the stretch member is formed in a space surrounded between the first and second pivotal connection strips and the pivotal connection pieces. Furthermore, because the flexible rubber sleeve placing tightly against the inner wall of the exhaust pipe has to be stretched repeatedly under the high temperature of the exhaust pipe, it will easily cause elastic fatigue of the flexible rubber sleeve and leakage of gas, and, therefore, will affect the inflation efficiency. Additionally, it is worth mentioning that, when a tire is fully inflated, the large amount of remained gas in the flexible rubber sleeve will gush out and scare the user when the gas nipple connector is disconnected and no atmospheric relief valve is disposed.

Therefore, a vehicle inflation device is required for improving the above mentioned problems and drawbacks.

### BRIEF SUMMARY OF THE INVENTION

It is an objective of the present invention to provide a simple structured vehicle inflation device for connecting to a vehicle exhaust pipe for inflating tires conveniently.

To achieve this and other objectives, a vehicle inflation device of the present invention includes a hollow body and a retractable pipe assembly for holding an accelerator pedal of a vehicle. The hollow body includes a front opening formed in a front end thereof and adapted for connecting with a vehicle exhaust pipe. Two opposite clamping lugs are formed on an outer wall of the front end of the hollow body, and a slot is formed in the front end of the hollow body and located between the clamping lugs. Each of the clamping lugs includes a screw hole, and a screw extends through the screw holes of the clamping lugs for locking the clamping lugs. A guiding pipe is disposed on a rear end of the hollow body, and a check valve is disposed inside the guiding pipe. The guiding pipe is connected with an end of a flexible rubber pipe which is adapted for connecting with a tire gas nipple. Two corresponding through-holes are disposed in the hollow body and each of the through-holes is provided with a screw seat. A main body of an atmospheric relief valve extends through the through-holes and has an outer screw thread engaging with the two screw seats. The retractable pipe assembly includes a first pipe and a second pipe. The first pipe includes a hook formed on an upper end thereof for hooking to a steering wheel of the vehicle. An internal end of the second pipe is retractably received in a bottom end of the first pipe. A pad is disposed on an external end of the second pipe for pressing against the accelerator pedal, allowing gas continuously exhausted from the vehicle exhaust pipe to inflate tires of the vehicle.

In a preferred form, a rubber gasket is sleeved in an inner periphery of the front opening of the hollow body.

In a preferred form, the screw seat is disposed on an inner wall of the hollow body corresponding to one of the through-holes and the outer wall of the hollow body corresponding to another one of the through-holes. The main body of the atmospheric relief valve is a hollow tube, and at least one slot is formed in an end edge of the hollow tube.

The present invention will become clearer in light of the following detailed description of illustrative embodiments of this invention described in connection with the drawings.

### DESCRIPTION OF THE DRAWINGS

FIG. 1 is an exploded, perspective view of partial components of a vehicle inflation device according to a first embodiment of the present invention.

FIG. 2 is a sectional view of a hollow body and a guiding pipe of the vehicle inflation device of FIG. 1.

FIG. 3 is a schematic view of a slot formed in the hollow body of FIG. 2.

FIG. 4 is a perspective view of the hollow body, the guiding pipe, and an atmospheric relief valve of the vehicle inflation device of FIG. 1.

FIG. 5 is a schematic view of a check valve of the vehicle inflation device of FIG. 1.

FIG. 6 is a perspective view of a retractable pipe assembly of the vehicle inflation device of the present invention.

FIG. 7 is another perspective view of the retractable pipe assembly of FIG. 6, with a second pipe of the retractable pipe assembly extended outwardly.

FIG. 8 is a schematic view illustrating use of the retractable pipe assembly of FIG. 6.

FIG. 9 is a schematic view illustrating use of the partial components of the vehicle inflation device of FIG. 1.

FIG. 10 is an exploded, perspective view of a hollow body and an atmospheric relief valve of a vehicle inflation device according to a second embodiment of the present invention.

FIG. 11 is a sectional view of the hollow body and the atmospheric relief valve of the vehicle inflation device of FIG. 10.

### DETAILED DESCRIPTION OF THE INVENTION

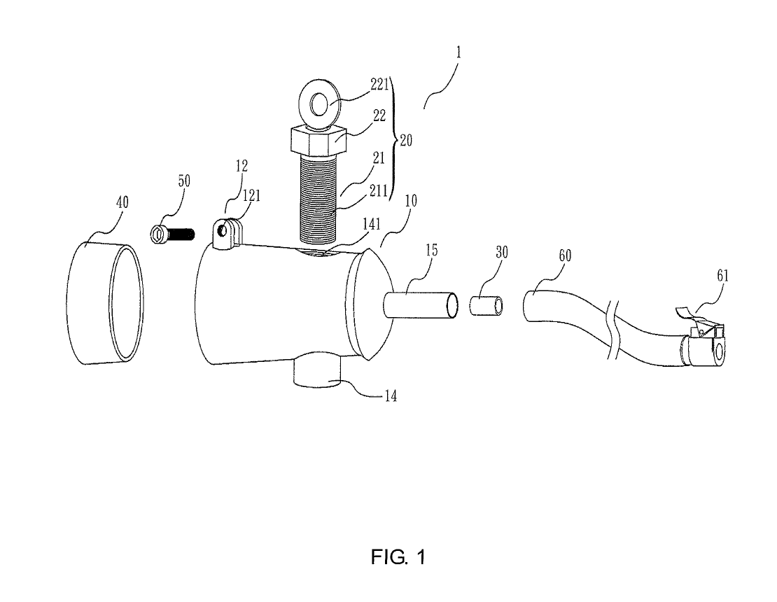

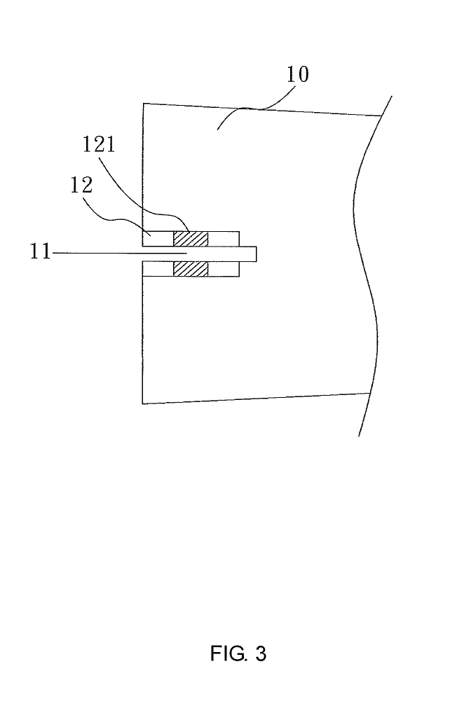

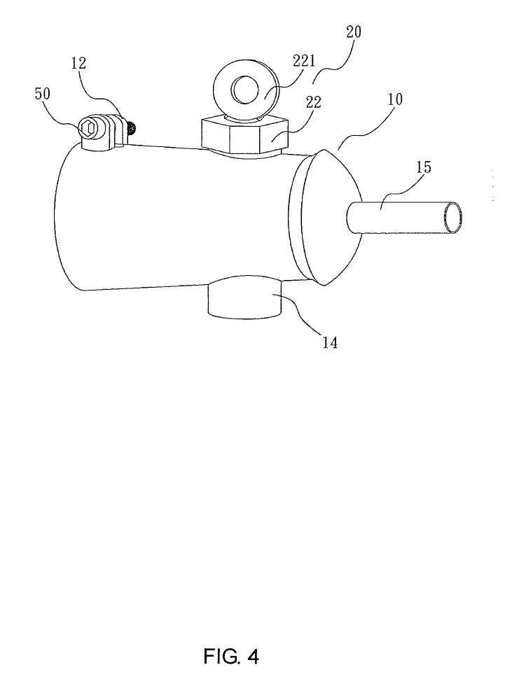

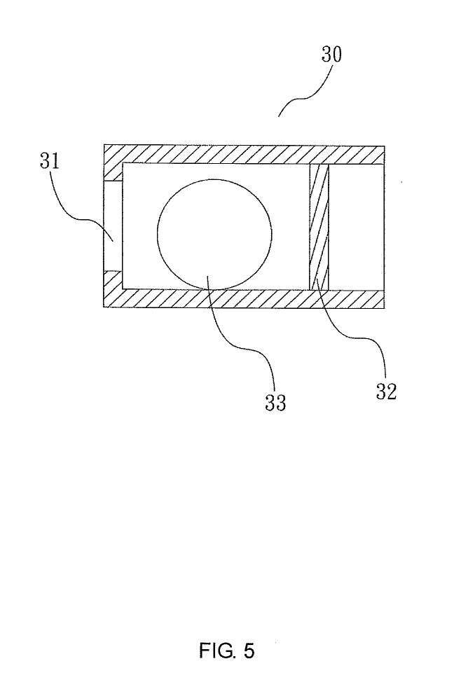

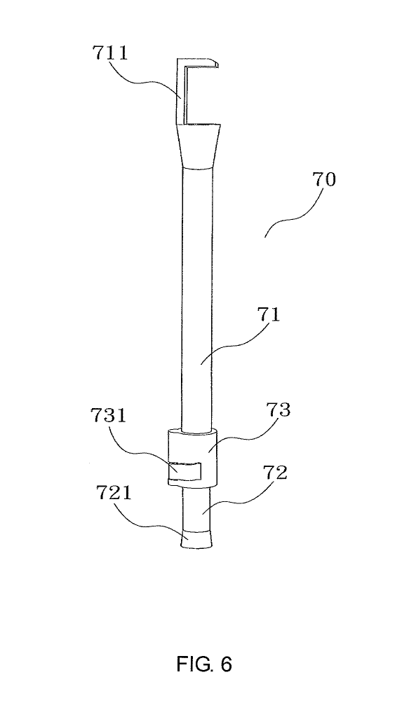

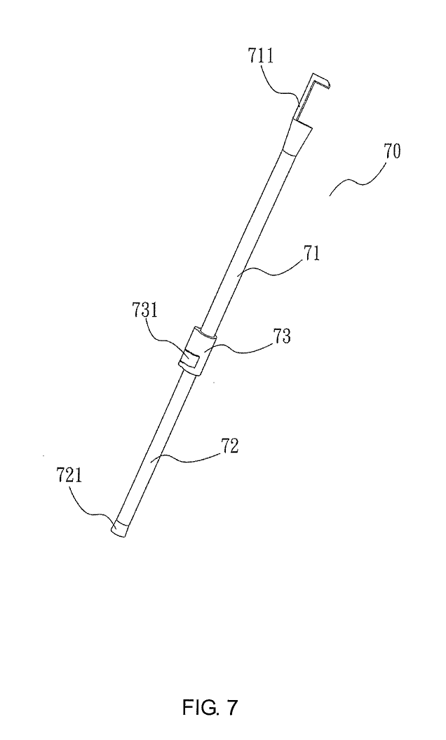

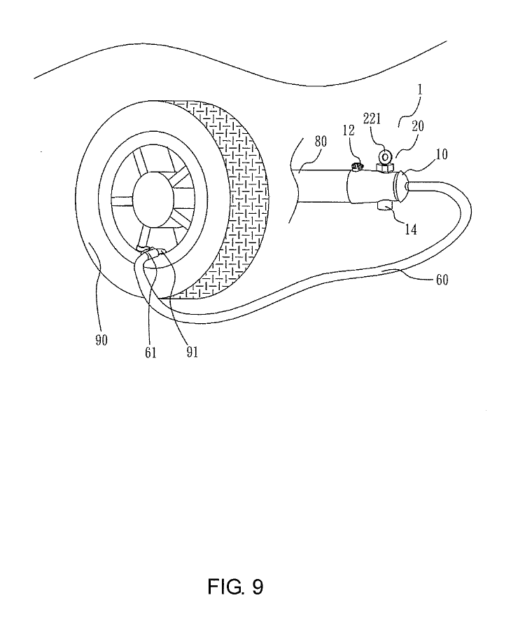

A vehicle inflation device 1 according to a preferred embodiment of the present invention is shown in FIGS. 1 through 9 of the drawings and includes a conical hollow body 10. The hollow body 10 includes a front opening (not labeled) formed in a front end thereof and adapted for connecting with a vehicle exhaust pipe 80 (see FIG. 9). In this embodiment, a rubber gasket 40 is sleeved in an inner periphery of the front opening of the hollow body 10. Two opposite clamping lugs 12 are formed on an outer wall of the front end of the hollow body 10, and a slot 11 is formed in the front end of the hollow body 10 and located between the opposite clamping lugs 12 (see FIG. 3). Each of the clamping lugs 12 has a screw hole 121 for a screw 50 to extend through. Thereby, the front opening of the hollow body 10 can be fit for installation of the vehicle exhaust pipe 80 with different diameters, and then the screw 50 is used for locking the clamping lugs 12, so that the vehicle exhaust pipe 80 can be connected with the hollow body 10 tightly. Furthermore, after the screw 50 is loose, the front opening of the hollow body 10 can be restored elastically to disconnect the hollow body 10 from the exhaust pipe 80.

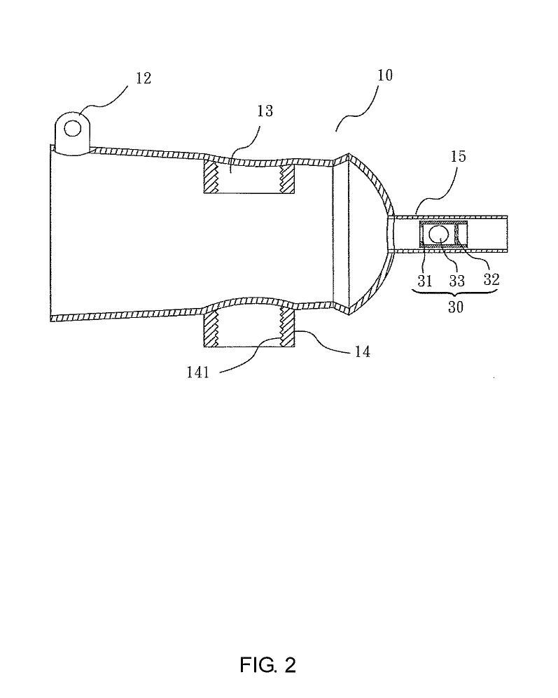

Two corresponding through-holes 13 are disposed in appropriate locations of the hollow body 10. A screw seat 14 is disposed on an inner wall of the hollow body 10 corresponding to one of the through-holes 13 and the outer wall of the hollow body 10 corresponding to another one of the through-holes 13 (see FIG. 2). Each of the screw seats 14 has an inner screw thread 141. An atmospheric relief valve 20 includes a main body 21 extending through the through-holes 13 and having an outer screw thread 211. The screw seats 14 are provided for engaging with the outer screw thread 211 of the main body 21. An enlarged portion 22 is disposed on an upper end of the main body 21, and a turn knob 221 is disposed on the enlarged portion 22 for operating discharging of gas. A guiding pipe 15 is disposed on a rear end of the hollow body 10, and a check valve 30 is disposed inside the guiding pipe 15. The guiding pipe 15 is sleeved and connected with an end of a flexible rubber pipe 60, and a gas nipple connector 61 is disposed at another end of the flexible rubber pipe 60. The check valve 30 is hollow and includes a reduced opening 31 with a smaller diameter formed in an end thereof, and a stopping bar 32 is disposed in an inner periphery of another end of the check valve 30 opposite to the reduced opening 31. A valve ball 33 is disposed in the check valve 30 and located between the reduced opening 31 and the stopping bar 32. The valve ball 33 has a diameter larger than the diameter of the reduced opening 31 for stopping reverse flow of gas.

The vehicle inflation device 1 of the present invention further includes a retractable pipe assembly 70. The retractable pipe assembly 70 includes a first pipe 71 and a second pipe 72. The first pipe 71 includes a hook 711 formed on an upper end thereof and a fixing seat 73 formed on a bottom end thereof. An outer diameter of the second pipe 72 is smaller than an inner diameter of the first pipe 71, and an internal end of the second pipe 72 is retractably received in the bottom end of the first pipe 71. A fixing buckle 731 is disposed on the fixing seat 73 of the first pipe 71 for fixing the second pipe 72 after the second pipe 72 is adjusted to a required length relative to the first pipe 71. Furthermore, a pad 721 is disposed on an external end of the second pipe 72.

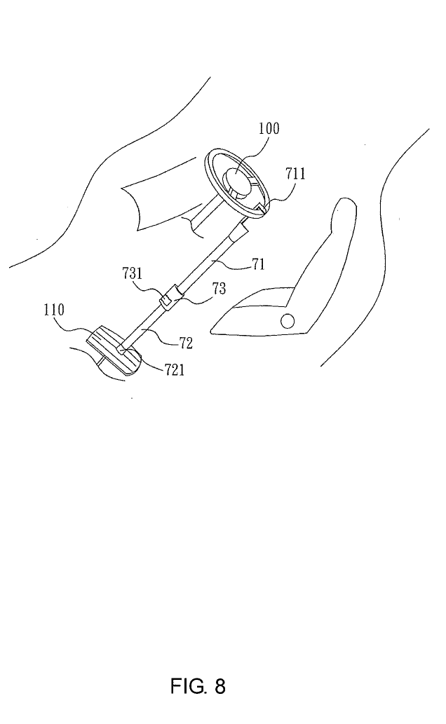

When the vehicle inflation device 1 of the present invention is used as shown in FIGS. 8 and 9, the hollow body 10 is connected and locked with the exhaust pipe 80. The rubber gasket 40 sleeved in the exhaust pipe 80 is used for achieving airtight and preventing gas leakage. The gas nipple connector 61 of the flexible rubber pipe 60 is engaged with a gas nipple 91 of a tire 90. Further, the retractable pipe assembly 70 can be adjusted with an appropriate length, such that the hook 711 of the first pipe 71 is hooked to a steering wheel 100 of a vehicle, and the pad 721 of the second pipe 72 is pressed against an accelerator pedal 110 for holding the accelerator pedal 110. Thus, the gas continuously exhausted from the exhaust pipe 80 can be used to inflate the tire 90.

The vehicle inflation device 1 of the present invention not only can be used for inflating the tire 90 conveniently, its structure is also simple. Furthermore, the check valve 30 inside the guiding pipe 15 can prevent gas from flowing reversely. Additionally, if the pressure of the tire 90 is too high, the turn knob 221 of the atmospheric relief valve 20 can be turned for discharging gas.

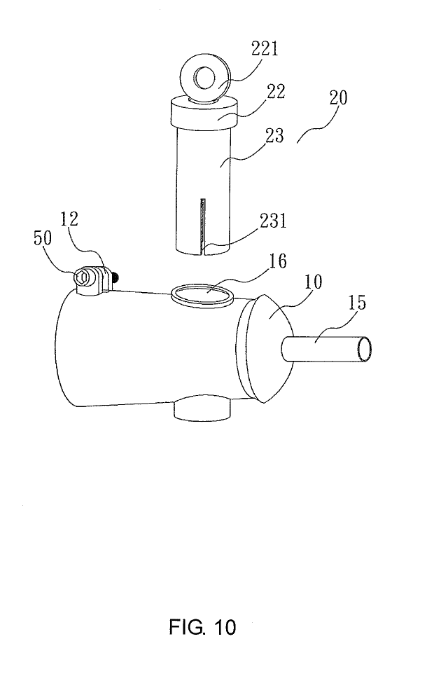

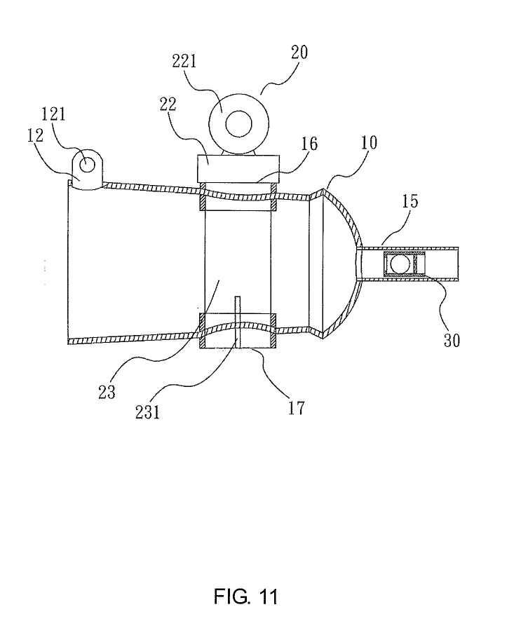

A hollow body 10 and an atmospheric relief valve 20 according to another embodiment of the present invention are shown in FIGS. 10 and 11. In the embodiment, two circular through-holes 16 and 17 are disposed in the hollow body 10. The atmospheric relief valve 20 includes a hollow tube 23 acting as the main body of the atmospheric relief valve 20 and extending through the circular through-holes 16 and 17. Further, at least one slot 231 is formed in an end edge of the hollow tube 23. When high pressure occurs in the tire 90 during inflation by gas exhaustion, the slot 231 of the atmospheric relief valve 20 can help to relieve the pressure for preventing the pressure of the tire 90 from becoming too high momentarily.

Although specific embodiments have been illustrated and described, numerous modifications and variations are still possible without departing from the essence of the invention. The scope of the invention is limited by the accompanying claims.

1. A vehicle inflation device comprising:
a hollow body including a front opening formed in a front end thereof and adapted for connecting with a vehicle exhaust pipe, with two opposite clamping lugs formed on an outer wall of the front end of the hollow body, with a slot formed in the front end of the hollow body and located between the clamping lugs, with each of the clamping lugs including a screw hole, with a screw extending through the screw holes of the clamping lugs for locking the clamping lugs, with a guiding pipe disposed on a rear end of the hollow body, with a check valve disposed inside the guiding pipe, with a flexible rubber pipe connected with the guiding pipe and adapted for connecting with a tire gas nipple, with two corresponding through-holes disposed in the hollow body and each of the through-holes provided with a screw seat, with a main body of an atmospheric relief valve extending through the through-holes and having an outer screw thread engaging with the screw seats; and
a retractable pipe assembly including a first pipe and a second pipe, with the first pipe including a hook formed on an upper end thereof for hooking to a steering wheel of a vehicle, with an internal end of the second pipe retractably received in a bottom end of the first pipe, with a pad disposed on an external end of the second pipe for pressing against an accelerator pedal of the vehicle to allow gas continuously exhausted from the vehicle exhaust pipe to inflate a tire.

2. The vehicle inflation device according to claim 1, wherein a rubber gasket is sleeved in an inner periphery of the front opening of the hollow body.

3. The vehicle inflation device according to claim 1, wherein the screw seat is disposed on an inner wall of the hollow body corresponding to one of the through-holes and the outer wall of the hollow body corresponding to another one of the through-holes, with the screw seat having an inner screw thread.

4. The vehicle inflation device according to claim 1, wherein the check valve is hollow and includes a reduced opening with a smaller diameter formed in an end thereof, with a stopping bar disposed in an inner periphery of another end of the check valve opposite to the reduced opening.

5. The vehicle inflation device according to claim 4, wherein a valve ball is disposed in the check valve and located between the reduced opening and the stopping bar.

6. The vehicle inflation device according to claim 1, wherein an enlarged portion is disposed on an upper end of the main body, and a turn knob is disposed on the enlarged portion for operating discharging of gas.

7. The vehicle inflation device according to claim 1, wherein an outer diameter of the second pipe is smaller than an inner diameter of the first pipe, with a fixing seat formed on a bottom end of the first pipe.

8. The vehicle inflation device according to claim 7, wherein a fixing buckle is disposed on the fixing seat of the first pipe.

9. The vehicle inflation device according to claim 1, wherein the main body of the atmospheric relief valve is a hollow tube, and at least one slot is formed in an end edge of the hollow tube.
